(19) United States
(12) Patent Application Publication
(10) Pub. No.: US 2026/0281044 A1
(43) Pub. Date: Sep. 17, 2026

(54) Application Quality of Experience Determination Based on Packet Flow Characteristics

(71) Applicant: Arista Networks, Inc., Santa Clara, CA (US)

(72) Inventors: Rikith Reddy Bachu, Hyderabad (IN); Aadarsh Singh, Prayagraj (IN); Karan Gupta, Pune (IN)

(21) Appl. No.: 19/078,565

(22) Filed: Mar. 13, 2025

(51) Int. Cl. H04L 47/24; H04W 28/04

(52) U.S. Cl. CPC H04L 47/24; H04W 28/04

(57) ABSTRACT

A network traffic analyzer may obtain metadata on network traffic conveyed between first and second hosts and may determine the quality of experience of an application executing on the first host based on the obtained network traffic data. In particular, the analyzer may identify a number of application data packets in a first network flow and a number of acknowledgement data packets in the opposite network flow. Based on comparing the ratio between the number of application data packets and the number of acknowledgement data packets to one or more thresholds, the analyzer may generate and provide an indication of quality of experience for the application.

### BACKGROUND

A communication system includes multiple network devices that are interconnected to form a network for conveying network traffic for hosts. The conveyed network traffic can include application data traffic, e.g., between client-side and server-side applications. Network issues and/or other issues can cause degradation in the application quality of experience for users of client and/or servers. Accordingly, it can be desirable to determine the application quality of experience or more specifically when there are issues degrading the application quality of experience.

### BRIEF DESCRIPTION OF THE DRAWINGS

FIG. 1 is a diagram of an illustrative networking system having an application quality of experience analyzer in accordance with some embodiments.

FIG. 2 is a diagram of an illustrative network device in accordance with some embodiments.

FIG. 3 is a diagram of illustrative network traffic between two host devices containing handshake messages, application data packets, and acknowledgement data packets in accordance with some embodiments.

FIG. 4 is a diagram of an illustrative transport layer data packet in accordance with some embodiments.

FIG. 5 is a diagram of illustrative application quality of experience analysis performed in connection with a time window within a communication session in accordance with some embodiments.

FIG. 6A is a diagram of different illustrative types of data packets identifiable based on their sizes in accordance with some embodiments.

FIG. 6B is a diagram of different illustrative types of application data packets identifiable based on their sizes in accordance with some embodiments.

FIG. 7 is a diagram of an illustrative aggregation time window for data aggregation based on data from smaller burst time windows in accordance with some embodiments.

FIG. 8 is a flowchart of illustrative operations for determining application quality of experience in accordance with some embodiments.

### DETAILED DESCRIPTION

A network can convey network traffic, e.g., in the form of frames, packets, datagrams, etc., between hosts or generally between devices in the network. In some illustrative configurations described herein as an example, hosts (e.g., clients and servers) may execute applications (e.g., client-side applications and/or server-side applications) and may transmit and receive application data for the executed applications via the network. Network issues and/or other issues can cause degradation in the quality of experience (QoE) of applications executing on the hosts, thereby adversely affecting user experience. As a proxy for application quality of experience, network traffic associated with application data traffic can be used to determine (e.g., estimate) the quality of experience of applications therefor, e.g., based on the manner in which application data traffic is conveyed through the network.

However, it can be challenging to determine the quality of experience of certain types of applications that convey their application traffic using protocols that provide transport reliability, such as applications that convey their application data traffic using a QUIC protocol (e.g., a protocol in compliance with Internet Engineering Task Force (IETF) Request for Comments (RFC) 9000 and/or other standards). As one illustrative example, web browser applications, among other applications, that use Hypertext Transfer Protocol (HTTP) (e.g., the third version of HTTP, HTTP/3, based on IETF RFC 9114) may be based on the QUIC protocol. In the example of QUIC-based applications (e.g., HTTP/3-based applications), unlike Voice over Internet Protocol (VoIP) applications which provides a continuous stream of network packets and unlike Transmission Control Protocol (TCP)-based applications which provide transparent reliability parameters in (accessible header fields of) network packets, QUIC-based applications (and other applications having similar characteristics) may convey network traffic in bursts and obscure reliability parameters in network packets (e.g., with encryption). Accordingly, determining the quality of experience of QUIC-based applications can be particularly challenging. However, challenges in determining quality of experience may be faced by applications using other protocols that provide transport reliability (e.g., TCP-based applications).

To overcome these challenges and/or impart other advantages, a network traffic analyzer may implement techniques with which the quality of experience of various types of applications (e.g., QUIC-based applications, TCP-based applications, other applications based on other protocols that provide transport reliability) can be determined. In illustrative configurations described herein in which the network traffic analyzer is used to characterize application quality of experience, the analyzer may sometimes be referred to as an application quality of experience analyzer. The network traffic analyzer may identify appropriate application data packets in a given network flow and acknowledgement data packets, responsive to the application data packets, in the opposite network flow. The network traffic analyzer may determine (e.g., estimate) application quality of experience using the number of application data packets relative to the number of acknowledgement data packets (e.g., a ratio of one-to-one, a ratio of two-to-one, a ratio of four-to-one, a ratio of six-to-one, etc.). The network traffic analyzer may obtain metadata on the network traffic (e.g., the number, size, timestamp, and/or other properties of the packets in both network flows), may perform analysis operations based on the network traffic metadata, and may provide output(s) (e.g., notifications) indicative of application quality of experience (e.g., issues therewith) based on these analysis operations. The network traffic analyzer may be implemented on network device(s) and/or on compute device(s) of a dedicated troubleshooting system. Illustrative details of network traffic analyzer(s) of this type are further described herein.

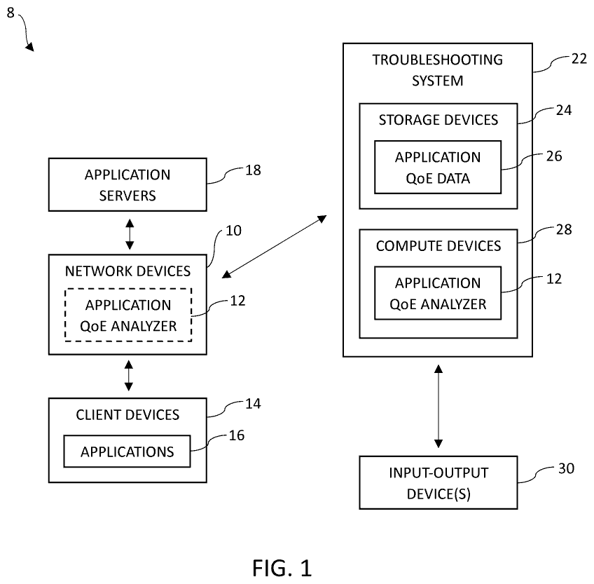

An illustrative networking system that includes a network traffic analyzer (e.g., an application quality of experience analyzer) is shown in FIG. 1. In the example of FIG. 1, the networking system may include one or more components of a network such as network 8. Network 8 may include, be, and/or form part of one or more local segments, one or more local subnets, one or more local area networks (LANs), one or more campus area networks, one or more metropolitan area networks, one or more wide area networks, one or more datacenter networks, one or more cloud networks, etc. Network 8 may include a wired network (portion) based on wired technologies or standards such as Ethernet (e.g., using copper cables and/or fiber optic cables) and wireless network portion(s) such as one or more wireless local area networks (WLANs). If desired, network 8 may also include internet service provider networks (e.g., the Internet) or other public service provider networks, private service provider networks (e.g., multiprotocol label switching (MPLS) networks), and/or other types of networks such as telecommunication service provider networks.

Network 8 may be implemented using one or more network devices that handle (e.g., process by modifying, forwarding, etc.) network traffic to convey information (e.g., application data) for user applications between end hosts and/or generally for other applications between devices. Network 8 can include networking equipment forming a variety of network devices such as network devices 10 that interconnect (end) hosts of network 8 (e.g., client devices 14, application servers 18, etc.). Network devices 10 of network 8 may include one or more wireless access points, one or more network switches (e.g., multi-layer (Layer 2 and Layer 3) switches, single-layer (Layer 2) switches, etc.), one or more bridges, one or more routers or gateways, one or more hubs, one or more repeaters, one or more firewalls, one or more devices serving other networking functions, one or more devices that include the functionality of two or more of these devices, and/or management equipment that manages and controls the operations of one or more of these network devices.

End hosts of network 8 (e.g., client devices 14 and/or application servers 18) can include computers, servers, portable electronic devices such as cellular telephones and laptops, other types of specialized or general-purpose host computing equipment (e.g., running one or more client-side applications 16 and/or server-side applications), network-connected appliances or devices, computing devices used by users or network administrators such as an administrator device (e.g., user input-output device 30), network service devices, and/or management equipment that manages and controls the operation of one or more other end hosts and/or network devices.

In some illustrative configurations described herein as an example, network devices 10 may include wireless access point(s) that implement a wireless network portion through which wireless end hosts (e.g., client devices 14) are communicatively (e.g., wirelessly) coupled to a wired network portion (e.g., formed by other network devices 10).

In the example of FIG. 1, each client device 14 (sometimes referred to as clients 14) may transmit and receive network traffic (e.g., application data packets) to support the execution of one or more (software) applications 16 (e.g., client-side applications) thereon. As examples, applications 16 may include video conferencing applications, VoIP applications, media streaming applications, web browsing applications, gaming applications, and/or other applications for which network traffic satisfying a corresponding quality of service is required or desired (e.g., to provide a satisfactory application quality of experience for the user of client device 14 executing the application 16). In particular, network devices 10 may convey the network traffic (e.g., application data traffic for one or more of these applications 16) from client devices 14 to application servers 18 and may convey network traffic (e.g., corresponding application data traffic for respective server-side applications executed on servers 18) from servers 18 to client devices 14. In some instances, applications 16 may include peer-to-peer applications, and network devices 10 may convey application data traffic between clients or peers (e.g., instead of to and from application servers 18).

From time to time, one or more network components (e.g., network devices 10, client devices 14, application servers 18, etc.) may experience issues that adversely impact the conveyance of application data traffic to and/or from applications 16, thereby adversely impacting the performance of applications 16 (e.g., the quality of experience of applications 16 experienced by the users of applications 16). To identify these network issues and/or other issues, and assist a network administrator in resolving these issues (e.g., by pinpointing when these issues are occurring), a network traffic analyzer or monitor such as application quality of experience (QoE) analyzer 12 (sometimes referred to as application traffic analyzer 12 or application traffic monitor 12) may be provided in the networking system of FIG. 1. In particular, application quality of experience analyzer 12 may monitor the quality of experience of and/or other metrics associated with application performance (e.g., the quality of application data conveyance through network 8 between clients 14 and servers 18). In particular, application quality of experience analyzer 12 may obtain metadata (e.g., the number or quantity of, the size of, ingress and/or egress timestamps, header data, and/or other properties of network packets) of network traffic conveyed between clients 14 and servers 18 to determine the quality of application data conveyance, and therefore the application quality of experience.

In illustrative configurations described herein as an example, a (network) troubleshooting system such as system 22, communicatively coupled to network device(s) 10, may implement application quality of experience analyzer 12. This example is merely illustrative. If desired, analyzer 12 may be implemented on one or more network devices 10 between client device(s) 14 and server(s) 18 instead of or in addition to being implemented on troubleshooting system 22. In other words, if desired, certain operations described herein to be performed by analyzer 12 may be performed by network device(s) 10 and other operations described herein to be performed by analyzer may be performed by troubleshooting system 22. Regardless of implementation, analyzer 12 may obtain data (e.g., metadata and/or other information) on network data packets conveyed traffic between clients 14 and servers 18 and generate application quality of experience data 26 based on the obtained network traffic data.

In one illustrative arrangement, troubleshooting system 22 (e.g., input-output interfaces thereof) may be communicatively coupled to network 8 (e.g., the components therein). As examples, troubleshooting system 22 (e.g., interface circuitry forming input-output interfaces thereof) may establish communication paths (e.g., sessions, connections, etc.) for communicating with the network components (e.g., network devices 10, client devices 14, application servers 18, etc.), with network management equipment that manage the operations of network devices 10 (e.g., network controllers), with server (virtual machine) management equipment that manage the operations of application servers 18, and/or generally with other sources of network traffic data.

Through these communication links, troubleshooting system 22 may obtain network traffic data (e.g., copies of network packets themselves, network packet metadata such as header information of the network packets, network packet count, network packet timestamps, network packet size, network traffic statistics, etc.) usable to determine the quality of application data conveyance through network 8, which is indicative of application quality of experience. As an example, troubleshooting system 22 may receive, from device 10, packet metadata for network traffic forwarded by device 10 between client 14 and server 18. Troubleshooting system 22 (e.g., analyzer 12 therein) may use the packet metadata to generate application quality of experience (QoE) data 26. Application QoE data 26 may include, for each application, indications of the time periods and/or the proportion of time during which application quality of experience is satisfactory or unsatisfactory (e.g., whether application quality of experience is satisfactory or unsatisfactory for each time window), indications of issues with application quality of experience, or generally metrics indicative of application quality of experience over time. In particular, troubleshooting system 22 may include one or more storage devices 24 configured to store application QoE data 26 (and/or network packet metadata from which QoE data 26 is derived).

To obtain and process the network packet data and/or perform analysis of the network packet data to determine application quality of experience, troubleshooting system 22 may include one or more compute devices 28 communicatively coupled to one or more storage devices 24. Compute device(s) 28 may include or provide (e.g., execute, implement, etc.) application QoE analyzer 12. In illustrative configurations described herein as an example, analyzer 12 may be implemented as a software process executing on compute device(s) 28 based on corresponding software instructions stored on storage device(s) 24. This is merely illustrative. If desired, analyzer 12 may be implemented as using dedicated hardware or in other manners.

While illustrative operations such as obtaining and processing network packet metadata, analyzing the network packet metadata, and generating of application quality of experience data 26 are sometimes described herein to be operations performed by analyzer 12, this is merely illustrative. In general, troubleshooting system 22 (e.g., compute devices 28 and/or storage devices 24) may be organized in any suitable manner to perform these operations. As described herein, analyzer 12 may generally refer to the portions of a troubleshooting system (e.g., one or more of compute devices 28 and storage devices 24, one or more software processes executing on device(s) 28, other hardware components in system 22, other devices in system 22, etc.) configured to perform and/or facilitate the performance of the analysis operations described herein in connection with analyzer 12.

Troubleshooting system 22 (e.g., input-output interfaces thereof) may be communicatively coupled to user input-output devices 30 (e.g., an administrator or user device such as a computing device operated by a network administrator, a network management server, etc.). Troubleshooting system 22 (e.g., analyzer 12) may provide application QoE data 26 and/or other suitable output(s) (e.g., notifications) generated or otherwise provided by analyzer 12 to device 30. As one illustrative example, troubleshooting system 22 may convey QoE data 26 and/or other information in one or more notifications to device 30 to be presented to a user via a user interface at device 30. Device 30 may be a client device 14 of network 8 or may be any suitable computing equipment having an output device configured to provide user output containing the notification(s). In some illustrative configurations described herein, these notifications may present indications of issues with application quality of experience and/or may generally provide results of the quality of experience analysis. As another illustrative example, troubleshooting system 22 may provide application QoE data 26 and/or other suitable information generated or otherwise provided by analyzer 12 to a network management device (e.g., a network management server that manages the operations of network devices 10 and/or other components of network 8). The network management device may be accessible by a user device and/or may subsequently provide a user device with a dashboard or other presentation mechanism usable to present application QoE data 26 and/or other suitable information generated or otherwise provided by analyzer 12.

In some illustrative implementations, troubleshooting system 22 may be implemented on server equipment and may sometimes be referred to as (network) troubleshooting server 22. The server equipment may include server hardware such as one or more blade servers, one or more rack servers, and/or one or more tower servers. Compute devices 28 and storage devices 24 for implementing the functions of troubleshooting server 22 (e.g., analyzer 12) may be provided as part of the server hardware.

As examples, each compute device 28 may include one or more processors such as central processing units (CPUs), graphics processing units (GPUs), microprocessors, general-purpose processors, host processors, microcontrollers, digital signal processors, programmable logic devices such as field programmable gate array (FPGA) devices, application specific system processors (ASSPs), application specific integrated circuit (ASIC) processors, and/or other types of processors (e.g., of other processor architecture types). Compute device(s) 28 may sometimes be referred to as the processing circuitry of troubleshooting system 22. Each storage device 24 may include non-volatile memory (e.g., flash memory, electrically-programmable read-only memory, a solid-state drive, hard disk drive storage, etc.), volatile memory (e.g., static or dynamic random-access memory), removable storage devices (e.g., storage devices removably coupled to the server hardware implementing the troubleshooting server), and/or other types of memory circuitry. Storage device(s) 24 may sometimes be referred to herein as the memory circuitry of troubleshooting system 22.

When implemented as described above, the memory circuitry formed from storage device(s) 24 may include one or more non-transitory (tangible) computer-readable storage media that store operating system software and/or any other software code, sometimes referred to as program instructions, software, data, instructions, or code. The processing circuitry formed from compute device(s) 28 may run (e.g., execute) operating system software and/or other software (including firmware) stored on the one or more non-transitory computer-readable storage media to perform the operations of troubleshooting system 22 (e.g., of analyzer 12). As just a few examples, based on the processing circuitry executing instructions stored on the memory circuitry, troubleshooting system 22 (e.g., to implement analyzer 12) may execute network packet metadata streaming process(es) and/or other process(es) for obtaining network packet metadata, application quality of experience analysis process(es), analysis result output process(es) that provide interface(s) by which notifications or other information are output to an output device 30, etc.

In other illustrative implementations, the components of troubleshooting system 22 may be implemented using non-server hardware (e.g., as part of other types of hardware systems). If desired, at least some (or all) of the portion(s) of analyzer 12 (e.g., the functions and operations of analyzer 12 as described above) may be executed on one or more network devices 10 (e.g., one or more wireless access points).

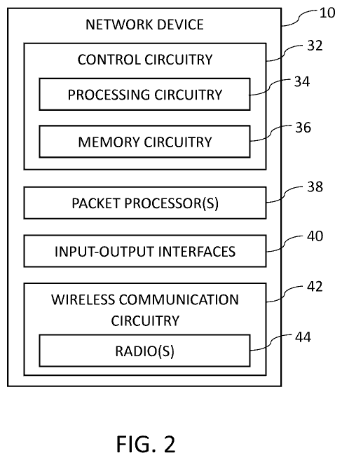

FIG. 2 is a diagram of an illustrative network device 10 such as a wireless access point or other types of network devices 10 in FIG. 1. As shown in FIG. 2, network device 10 may include control circuitry 32 having processing circuitry 34 and memory circuitry 36, one or more packet processors 38, input-output interfaces 40, wireless communication circuitry 42, and/or other components. Some components of the network device illustrated in FIG. 2 may be omitted, depending on the type of network device being implemented. For example, in configurations in which network device 10 (FIG. 2) is a wireless access point, network device 10 in FIG. 2 may include wireless communication circuitry 42 (and/or may omit packet processor(s) 38). In other configurations such as when network device 10 in FIG. 2 implements a network switch, a router, a gateway, or another type of network device, network device 10 (FIG. 2) may omit wireless communication circuitry 42. In general, different types of network devices in network 8 may have some of the same components as and some components different from the components of network device 10 as shown in FIG. 2.

Processing circuitry 34 may include one or more processors such as central processing units (CPUs), graphics processing units (GPUs), microprocessors, general-purpose processors, host processors, microcontrollers, digital signal processors, programmable logic devices such as field programmable gate array (FPGA) devices, application specific system processors (ASSPs), application specific integrated circuit (ASIC) processors, and/or other types of processors (e.g., of other processor architecture types).

Processing circuitry 34 may run (e.g., execute) a network device operating system and/or other software (including firmware) that is stored on memory circuitry 36 communicatively coupled to processing circuitry 34. Memory circuitry 36 may include one or more non-transitory (tangible) computer-readable storage media that store the operating system software and/or any other software code, sometimes referred to as program instructions, software, data, instructions, or code. In particular, memory circuitry 36 may include non-volatile memory (e.g., flash memory, electrically-programmable read-only memory, a solid-state drive, hard disk drive storage, etc.), volatile memory (e.g., static or dynamic random-access memory), removable storage devices (e.g., storage devices removably coupled to device 10), and/or other types of memory circuitry.

Processing circuitry 34 and memory circuitry 36 as described above may sometimes be referred to collectively as control circuitry 32 (e.g., implementing a control plane of network device 10). As just a few examples, processing circuitry 34 may execute network device control plane software such as operating system software, routing policy management software, routing protocol agents or processes, routing information base agents, and other control software, may be used to support the operation of protocol clients and/or servers (e.g., to form some or all of a communications protocol stack), may be used to support the operation of packet processor(s) 38, may store packet forwarding information, may execute packet processing software, and/or may execute other software instructions that control the functions of network device 10 and the other components therein.

Packet processor(s) 38 may be used to implement a data plane or forwarding plane of network device 10 and may therefore sometimes be referred to herein as data plane processor(s) or data plane processing circuitry. Packet processor(s) 38 may include one or more processors such as programmable logic devices (e.g., field programmable gate array (FPGA) devices), application specific system processors (ASSPs), application specific integrated circuit (ASIC) processors, central processing units (CPUs), graphics processing units (GPUs), microprocessors, general-purpose processors, host processors, microcontrollers, digital signal processors, and/or other types of processors (e.g., of other processor architecture types).

A packet processor 38 may receive incoming (ingress) network traffic via input-output interfaces 40, parse and analyze the received network traffic, process the network traffic based on packet forwarding decision data (e.g., in a forwarding information base) and/or in accordance with network protocol(s) or other forwarding policy, and forward (or drop) the network traffic accordingly (e.g., egress the processed network traffic via input-output interfaces 40). The packet forwarding decision data may be stored on memory circuitry integrated as part of and/or separate from packet processor 38 (e.g., on content-addressable memory), and/or on a portion of memory circuitry 36. Memory circuitry for packet processor 38 may include volatile memory, non-volatile memory, and/or other types of memory circuitry.

Input-output interfaces 40 (e.g., network interfaces) may include one or more different types of communication interfaces such as Ethernet interfaces, optical interfaces, and/or other types of communication interfaces for connecting network device 10 to the Internet, a local area network, a wide area network, a mobile network, and/or generally other network device(s) in network 8, peripheral devices, and computing equipment (e.g., host equipment such as server equipment, client devices, etc.).

In illustrative configurations described herein as an example, input-output interfaces 40 may include Ethernet interfaces implemented using and therefore including (Ethernet) ports. In particular, physical layer and/or data link layer interface circuitry in network device 10 may be coupled to the ports and use the ports to form Ethernet interfaces with the desired interface configurations. The ports may be physically coupled and electrically connected to corresponding mating connectors of external equipment, when received at the ports, and may have different form-factors to accommodate different cables, different modules, different devices, or generally different external equipment.

Network device 10 (e.g., when implementing a wireless access point) may include wireless communication circuitry 42 configured to communicate wirelessly with client devices 14 (FIG. 1) and generally provide wireless communication capabilities. Wireless communication circuitry 42 may include one or more radios 44 (e.g., WLAN radios), radio-frequency transceiver circuitry, radio-frequency front-end circuitry, and one or more antennas. Wireless communication circuitry 42 may include components (e.g., one or more radios 44, transceiver circuitry, front-end circuitry, and one or more antennas) configured to operate in a 2.4 GHz radio-frequency band, a 5 GHz radio-frequency band, a 6 GHz radio-frequency band, and/or other radio-frequency bands. Radio(s) 44 may use the one or more antennas to transmit radio-frequency signals to and receive radio-frequency signals from one or more client devices 14. While wireless communication circuitry 42 is shown as a separate element from processing circuitry 34, this is merely illustrative. If desired, portions of wireless communication circuitry 42 (e.g., radio functionalities) may be implemented as a portion of processing circuitry 34.

The configuration of network device 10 described in connection with FIG. 2 is merely illustrative. If desired, network device 10 may include other components. As an example, these other components may include a system bus and/or other communication paths that couple the internal components of network device 10 to one another, to power management and/or supply circuitry, etc. In general, each component of network device 10 may be coupled to control circuitry 32 (e.g., processing circuitry 34 and/or memory circuitry 36) via one or more paths that enable the reception and transmission of control signals, data, and/or other information therebetween.

When network device 10 implements analyzer 12 (or at least a portion of analyzer 12, such as some functions and/or operations thereof), analyzer 12 may be implemented as a software process executing on processing circuitry 34 by processing corresponding instructions stored on memory circuitry 36. As examples, processing circuitry 34 when implementing analyzer 12 may receive network traffic (e.g., conveyed between clients 14 and servers 18 for an application 16), may obtain metadata or other information on the network traffic (e.g., on the data packets therein), may provide the obtained metadata to system 22 (e.g., analyzer 12 at least partly implemented therein) for quality of experience analysis, may locally analyze the network traffic metadata (e.g., the numbers of different types of data packets, the header information of data packets, the sizes of data packets, the timestamps of data packets, etc.) to obtain application quality of experience data 26, and/or may provide application quality of experience data 26 and/or network traffic data (e.g., copies of data packets, metadata gathered on the forwarded data packets, etc.) to system 22.

Client-side applications and server-side applications may generate, receive, process, consume, output, and/or generally handle application data during application execution (e.g., to perform the desired operations of the applications on clients 14 and/or server 18). Some of this application data may be exchanged between clients and servers, or generally between hosts. Such application data may be conveyed across a network (e.g., network 8 in FIG. 1) using different mechanisms, or generally in different manners, (e.g., using different protocols, with different cadence such as in a continuous data stream, in bursts at regular or irregular intervals, etc.) between hosts such as client 14 and server 18, depending on the types of application. Accordingly, analyzer 12 may perform different types of application quality of experience analysis depending on the manner in which the application data is conveyed across network 8.

Configurations in which application quality of experience analysis, as described herein, is performed by analyzer 12 for applications that convey application data packets using a user datagram protocol (UDP) as the transport layer protocol, using a QUIC protocol (e.g., in accordance with or generally in compliance with IETF RFC 9000 and/or other QUIC-based standards) to provide reliability for data compliance and security (e.g., implemented using Transport Layer Security (TLS) such as TLS 1.3), and/or using Hypertext Transfer Protocol (HTTP) (e.g., HTTP version 3 (HTTP/3)) are sometimes described herein as an example. If desired, the application quality of experience analysis, as described herein, may be performed by analyzer 12 for other types of applications (e.g., that convey application data packets in other manners such as application data packets conveyed using TCP or other protocols that provide transport reliability).

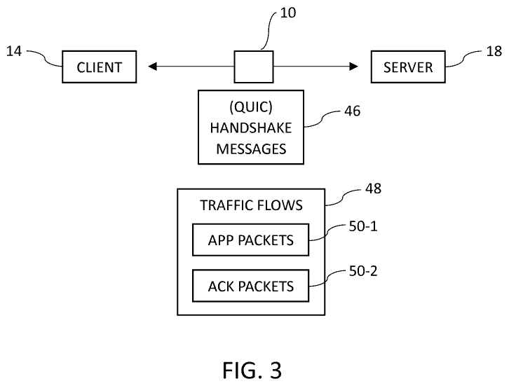

FIG. 3 is an illustrative diagram of an illustrative manner in which application traffic is conveyed between a client (device) 14 (e.g., a client-side application 16 executing thereon) and a server 18 (e.g., a server-side application executing thereon). As shown in FIG. 3, prior to conveying application data across the network, a set of handshake messages 46 may be conveyed between client 14 and server 18 to establish a communication session (e.g., to open and establish a communication connection for conveying the application data) therebetween. These messages may be conveyed using UDP as the transport layer protocol (e.g., identifying corresponding UDP ports to form the communication session). In illustrative configurations in which the QUIC protocol is used, messages 46 may include three QUIC handshake messages (e.g., a three-way or three-message handshake that incorporates TLS handshake data).

Following the establishment of the communication connection (e.g., the QUIC connection) between client 14 and server 18, data packets associated with application traffic flows may be conveyed using the communication connection between client 14 and server 18. In particular, the data packets being conveyed in using this communication connection may include data packets associated with a first traffic flow 48 from client 14 to server 18 and a second traffic flow from server 18 to client 14. Each of these traffic flows 48 may include application data packets 50-1 and acknowledgement data packets 50-2 (e.g., that acknowledge the reception of corresponding data packets 50-1 or other acknowledgement-eliciting packets in the opposite traffic flow).

Intervening network device(s), such as a network device 10 (e.g., a wireless access point), between client 14 and server 18 may receive and forward network traffic such as messages 46 (e.g., packets containing messages 46), application data packets 50-1, and acknowledgement data packets 50-2 in both traffic flow directions (e.g., from client 14 to server 18 and from server 18 to client 14). Accordingly, intervening device 10 may be configured to obtain metadata or other information on these packets for quality of experience analysis (e.g., performed locally by analyzer 12 implemented on processing circuitry 34 thereon and/or performed remotely by analyzer 12 implemented on compute device(s) 28).

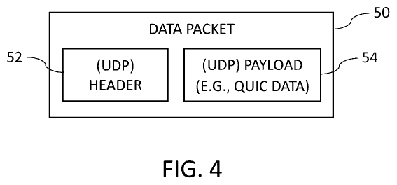

An illustrative data packet 50 (e.g., application data packet 50-1, acknowledgement data packet 50-2, a data packet containing handshake message 46, etc.) is shown in FIG. 4. In the example of FIG. 4, packet 50 may include a header 52 such as a UDP header (e.g., containing UDP header fields and other header data therein such as source and destination UDP ports) and may include a payload such as a UDP payload 54. UDP payload 54 may include QUIC data (e.g., one or more QUIC packets) in accordance with or in compliance with a QUIC protocol. In other words, the QUIC packet(s) may be encapsulated with a UDP header. The illustrative configuration of packet 50 in FIG. 4 is merely illustrative. If desired, data packet 50 may include additional information such as an Internet Protocol (IP) header (that encapsulates the UDP header and payload, as the IP payload), an Ethernet frame header, etc.

It can be challenging to analyze certain types of data packets such as QUIC-based data packets to determine the quality of application data conveyance, and consequently the application quality of experience (e.g., user experience when using a client-based application on a client device). In particular, data packets, or more specifically QUIC data (e.g., in payload 54), conveyed using an established QUIC connection between a client and a server can be encrypted. Accordingly, any transport reliability parameters (e.g., parameters that enable packet loss recovery capabilities, retransmission capabilities, and/or other data integrity and accuracy capabilities, such as sequence numbers or packet numbers and acknowledgement parameters) used in the QUIC protocol are provided as part of payload 54, which can be opaque (e.g., encrypted) and inaccessible to an intervening network device 10 seeking to analyze these transport reliability parameters to determine application quality of experience. Additionally, because applications using QUIC-based data packets, unlike VoIP or conferencing applications, can convey data packets in (regular or irregular) bursts and are not expected to convey continuous streams of data packets, the traffic patterns desired or intended by each application may be unknown and may further be challenging to characterize (e.g., for determining whether the current traffic pattern is satisfactory).

To overcome these challenges (e.g., the lack of usable reliability parameters in the data packets and uncertain traffic patterns for these application) and/or impart other advantages, analyzer 12 may use techniques based on the relative numbers of data packets of different types in different flows to determine (e.g., estimate) the quality of experience of applications (e.g., QUIC-based applications).

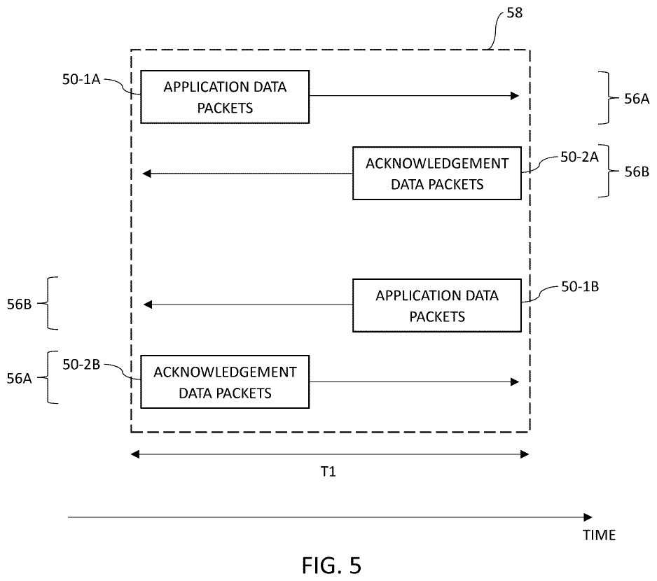

FIG. 5 shows an illustrative time window (e.g., time window 58) during which network traffic (e.g., data packets) associated with a communication connection (e.g., a QUIC connection) for an application can be analyzed by analyzer 12 to determine quality of experience and/or generate quality of experience data 26 (FIG. 1) for the application. In illustrative configurations sometimes described herein as an example, the data packets conveyed in FIG. 5 may be the data packets conveyed between client 14 and server 18, and received and forwarded by intervening network device 10 in the example of FIG. 3. Intervening network device 10 may provide metadata on these data packets (e.g., the number of data packets, the sizes of these data packets, the header information of these data packets that identify the network flows to which they belong, timestamp information that indicate the time windows to which the data packets belong, copies of these data packets, etc.) to analyzer 12 (e.g., a local process executing on processing circuitry 34 on device 10, a remote process executing on compute device 28 of troubleshooting system 12, etc.).

In the example of FIG. 5, within time window 58 that spans time period T1, a first host (e.g., client 14) may transmit application data packets 50-1A to a second host (e.g., server 18) that is forwarded by intervening network device(s) 10. Responsive to receiving application data packets 50-1A, the second host (e.g., server 18) may transmit acknowledgement data packets 50-2A back to the first host (e.g., client 14) through intervening network device(s). Within the same time period T1, the second host (e.g., server 18) may also transmit application data packets 50-1B to the first host (e.g., client 14) through intervening network device(s) 10. Responsive to receiving application data packets 50-1B, the first host (e.g., client 14) may transmit acknowledgement data packets 50-2B to the first host (e.g., server 18) through intervening network device(s) 10.

In certain scenarios, healthy or satisfactory network traffic flow and therefore good application quality of experience can be indicated by a relatively high ratio between (the number of) application data packets and (the number of) acknowledgement data packets (responsive to the same application data packets). For example, in illustrative configurations in which the data packets in FIG. 5 are conveyed using the QUIC protocol (e.g., in accordance with or in compliance with RFC 9000), the number of acknowledgement-eliciting packets in a given direction should be at least twice the number of acknowledgement data packets in the opposite direction.

Accordingly, analyzer 12 may obtain, based on the metadata gathered by intervening device 10 on the forwarded data packets (e.g., based on timestamp information indicating data packets in window 58, based on header information indicating data packets belonging to this first network flow, based on packet sizes that differentiate different types of packets, etc.), a number of application data packets 50-1A belonging to a first network flow in flow direction 56A and a number of acknowledgement data packets 50-2A in a second (opposite) network flow in flow direction 56B. Analyzer 12 may determine a ratio between the number of application data packets 50-1A and the number of acknowledgement data packets 50-2A (e.g., a ratio of application data packets to acknowledgement data packets). This first ratio may be used to indicate the quality of the application data transmission traffic flow (e.g., from the perspective of a client-side application 16).

Similarly, analyzer 12 may obtain, based on the metadata gathered by intervening device 10 on the forwarded data packets (e.g., based on timestamp information indicating data packets in window 58, based on header information indicating data packets belonging this second network flow, based on packet sizes that differentiate different types of packets, etc.), a number of application data packets 50-1B belonging to the second network flow in flow direction 56B and a number of acknowledgement data packets 50-2B belonging to the first network flow in flow direction 56A. Analyzer 12 may determine a ratio between the number of application data packets 50-1B and the number of acknowledgement data packets 50-2B (e.g., a ratio of application data packets to acknowledgement data packets). This second ratio may be used to indicate the quality of the application data reception traffic flow (e.g., from the perspective of the client-side application 16). Based on the first and second ratios, an indication of the quality of bidirectional application data traffic flows, and therefore the overall application quality of experience (e.g., experienced by a user of the client-side application 16) may be generated. As examples, this indication of application quality of experience may be an indication of whether or not application quality of experience is satisfactory, whether an issue with quality of experience is identified, or a degree to which quality of experience is satisfactory or unsatisfactory.

In particular, analyzer 12 may compare each of the first and second ratios to one or more ratio thresholds to determine whether or not the corresponding application data network flow is satisfactory. For example, if the first ratio is greater than a ratio threshold (e.g., an application data to acknowledgement ratio threshold of at least two such as a ratio threshold of two, three, four, five, etc.), the first ratio (and consequently the quality of the application data transmission traffic flow) may be determined by analyzer 12 to be satisfactory. If the first ratio is less than the ratio threshold, the first ratio (and consequently the quality of the application data transmission traffic flow) may be determined by analyzer 12 to be unsatisfactory.

Similarly, if the second ratio is greater than a ratio threshold that is the same as or different than the ratio threshold used for the first ratio (e.g., an application data to acknowledgement ratio threshold of at least two such as a ratio threshold of two, three, four, five, etc.), the second ratio (and consequently the quality of the application data reception traffic flow) may be determined by analyzer 12 to be satisfactory. If the second ratio is less than the ratio threshold, the second ratio (and consequently the quality of the application data reception traffic flow) may be determined by analyzer 12 to be unsatisfactory.

These two ratios and/or other indications of application quality of experience (e.g., results of comparisons of these two ratios with a ratio threshold, whether or not quality of experience is satisfactory, etc.) for time window 58 may be provided and stored by analyzer 12 as QoE data 26 in FIG. 1. The same types of information may be generated and stored for additional time windows as part of QoE data 26 by analyzer 12 after performing the same type of ratio analysis as described in connection with FIG. 5 for the additional time windows. The same types of information may be generated and stored for additional communication sessions for the same or different applications (e.g., additional QUIC connections that include corresponding bidirectional application data traffic flows) as part of QoE data by analyzer 12 after performing the same type of ratio analysis as described in connection with FIG. 5 for the additional communication sessions for the same or different applications.

These ratios and/or other indications of application quality of experience (e.g., results of comparisons of these two ratios with a ratio threshold, whether or not quality of experience is satisfactory, etc.) generated for different time windows and/or for different applications may be provided as output to one or more input-output devices 30 (FIG. 1). These outputs can provide information on the determined application quality of experience and/or can provide notifications of issues with application quality determined based on the ratio analysis.

Application data packets 50-1A and acknowledgement data packets 50-2B are in the same network flow in direction 56A. Analyzer 12 may determine whether a data packet forwarded in direction 56A is an application data packet 50-1A or an acknowledgement data packet 50-2B based on its packet size (e.g., its payload size), e.g., because packets 50-1A and packets 50-2B are encrypted. Similarly, application data packets 50-1B and acknowledgement data packets 50-2A are in the same network flow in direction 56B. Analyzer 12 may determine whether a data packet forwarded in direction 56B is an application data packet 50-1B or an acknowledgement data packet 50-2A based on its packet size (e.g., its payload size), e.g., because packets 50-1B and packets 50-2A are encrypted. In general, transport reliability parameters, packet type information, packet payload, and other parts of each of packets 50-1A, packets 50-1B, packets 50-2A, and packets 50-2B may be encrypted for data security.

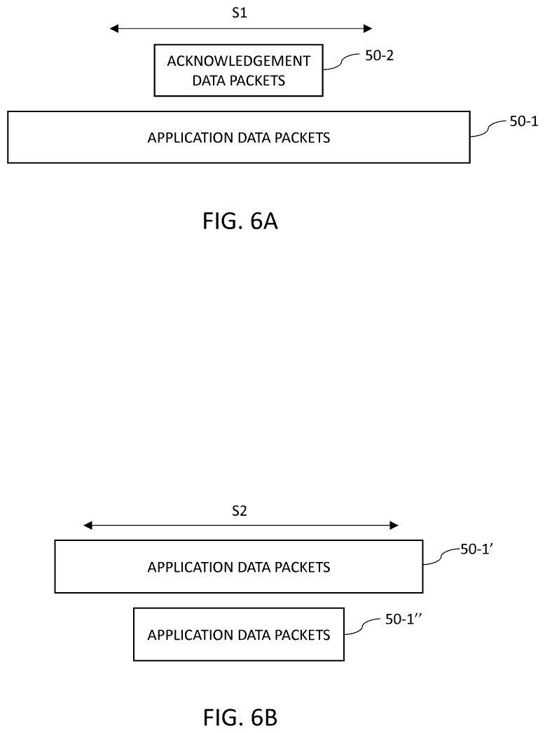

In particular, as shown in the example of FIG. 6A, analyzer 12 may maintain a packet size threshold S1 (e.g., a maximum acknowledgement data packet size threshold) and may compare the size of each data packet (e.g., packets 50-1A, 50-1B, 50-2A, 50-2B) to threshold S1 to determine whether the compared data packet is an acknowledgement packet or an application data packet (or generally a data packet that is not an acknowledgement packet). As the purpose of acknowledgement data packets is to acknowledgement data packet reception (and not to convey substantial amounts of data), the sizes of acknowledgement data packets 50-2 (e.g., the sizes of their payloads 54) should be minimal and distinguishable from at least the majority of application data packets 50-1 which have larger sizes because of the substantial amounts of application data carried therein (e.g., in their payloads 54). Accordingly, based on the size of a packet being less than threshold S1, analyzer 12 may identify the packet as an acknowledgement data packet 50-2. Based on the size of the packet being greater than threshold S1, analyzer 12 may identify the packet as not being an acknowledgement data packet (e.g., as being an application data packet 50-1). In such a manner, analyzer 12 may distinguish between acknowledgement data packets and application data packets to perform the ratio analysis described in connection with FIG. 5.

Furthermore, the application data packets 50-1 used to perform the ratio analysis described in connection with FIG. 5 may be a subset of all application data traffic conveyed between the two hosts (e.g., client 14 and server 18) during time period T1 using the communication connection. In other words, application data packets 50-1A may be a subset of (e.g., may not be all of) the application data packets conveyed from client 14 to server 18 during time period T1 using this communication connection. Similarly, application data packets 50-1B may be a subset of (e.g., may not be all of) the application data packets conveyed from server 18 to client 14 during time period T1 using this communication connection. In other words, analyzer 12 may filter application data packets and use a selected set of application data packets to calculate the first and second ratios in the manner described in connection with FIG. 5.

FIG. 6B shows illustrative types of application data packets 50-1. In particular, for the purposes of determining application quality of experience, it may be desired (e.g., more useful, more accurate, etc.) to characterize the transmission and/or reception quality of bursts of several application data packets 50-1′, rather than small one-off application data packets 50-1″. For the sake of efficiency, application data conveyed in bursts of data packets should send large amounts (e.g., the maximum allowable amounts) of data therein to reduce the number of data packets needed to convey the same amount of application data. Accordingly, the sizes of data packets 50-1′ (transmitted or received in a burst) may typically be larger than data packets 50-1″ (e.g., one-off data packets).

As such, analyzer 12 may maintain packet size threshold S2 (e.g., a minimum application data packet size threshold) and may compare sizes of application data packets (e.g., or generally all data packets including acknowledgement packets) to threshold S2 to determine application data packets 50-1′ send in bursts. In particular, based on a size of an application data packet being greater than threshold S2, analyzer 12 may identify the packet as an application data packet 50-1′ (e.g., packet 50-1A or 50-1B in FIG. 5) used to perform the ratio analysis described in connection with FIG. 5. Based on the size of an application data packet being less than threshold S2, analyzer 12 may identify the packet as being an application data packet 50-1″ not used to perform the ratio analysis described in connection with FIG. 5. In other words, determined in this manner, application data packets 50-1A and 50-1B described in connection with FIG. 5 and used to generate the first and second ratios may include application data packets 50-1′ but not application data packets 50-1″.

Analyzer 12 may perform the ratio analysis described in connection with FIG. 5 for a given time window 58 if analyzer 12 determines the given time window 58 to be a valid time window for performing the ratio analysis. As examples, analyzer 12 may determine that a time window 58 (e.g., time window 58 in FIG. 5) is valid if the number of application data packets in a given network flow is greater than a minimum (threshold) number of application data packets and if the number of acknowledgement data packets in the reverse network flow is greater than a minimum (threshold) number of acknowledgement data packets.

As a first example, if application data packets 50-1A in FIG. 5 (having sizes greater than threshold S2) is greater than the minimum number of application data packets desired to perform the ratio analysis and if acknowledgement data packets 50-2A in FIG. 5 is greater than the minimum number of acknowledgement data packets desired to perform the ratio analysis, analyzer 12 may determine window 58 to be valid for at least characterizing the quality of application data conveyance in direction 56A and determine the ratio between the number of packets 50-1A and the number of packets 50-2A.

As a second example, if application data packets 50-1B in FIG. 5 (having sizes greater than threshold S2) is greater than the minimum number of application data packets (e.g., the same number as or a different number than in the above first example) and if acknowledgement data packets 50-2B in FIG. 5 is greater than the minimum number of acknowledgement data packets (e.g., the same number as or a different number than in the above first example), analyzer 12 may determine window 58 to be valid for at least characterizing the quality of application data conveyance in direction 56B and determine the ratio between the number of packets 50-1B and the number of packets 50-2B.

In some illustrative configurations described herein, analyzer 12 may determine a given time window 58 to be valid and perform the ratio analysis only if both ratios in both flow directions (e.g., directions 56A and 56B) can be determined.

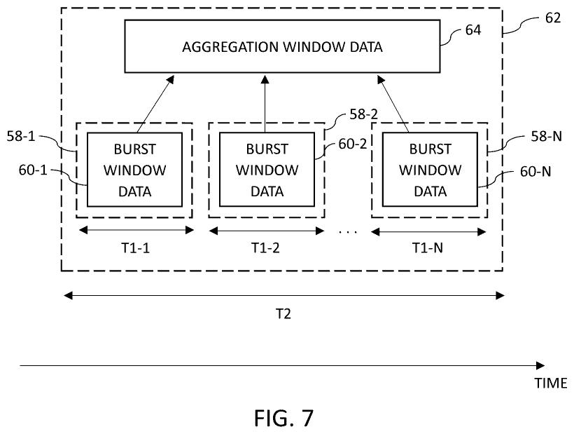

The time window 58 in FIG. 5 may be one of many such time windows 58 for the same communication connection between the two hosts and for which the ratio analysis may be performed by analyzer 12. FIG. 7 is a diagram of an illustrative aggregation time window containing multiple time windows 58 and for which overall application quality of experience data 26 (FIG. 1) can be generated and stored. A given aggregation time window 62 may include any suitable number of time windows 58 (sometimes referred to as burst windows 58) during which bursts of application data packets 50-1′ (FIG. 6B) are conveyed. As shown in FIG. 7, aggregation time window 62 includes time windows 58-1, 58-2, . . . , 58-N, spanning respective time periods T1-1, T1-2, . . . , T1-N. The total of these time periods T1-1, T1-2, . . . , T1-N may be less than or equal to time period T2 for aggregation time window 62.

Analyzer 12 may obtain burst window data 60 (e.g., the numbers of application data packets and acknowledgement data packets in both network flow directions, the application data to acknowledgement ratios for both application data flow directions, and/or other information described in connection with FIGS. 5 and 6) for each time window 58 and aggregate burst window data 60-1, 60-2, . . . , 60-N into aggregation window data 64 (e.g., an aggregated version of the numbers of application data packets and acknowledgement data packets in both network flow directions across multiple windows 58, an aggregated version of the application data to acknowledgement ratios for both application data flow directions for multiple windows 58, and/or aggregated versions of other information described in connection with FIGS. 5 and 6).

Aggregation window data 64 (e.g., part of QoE data 26 in FIG. 1) may be usable to characterize application quality of experience for the connection between two hosts (e.g., client 14 and server 18) across time period T2. Because the duration of time period T2 can be selected by analyzer 12 (e.g., to include any suitable number of windows 58), application quality of experience can be characterized across any desired time period.

Analyzer 12 may perform aggregation in any number of suitable manners. As an example, analyzer 12 may perform a window-based aggregation using the indication of quality of experience for each time window 58 (e.g., whether the ratios determined for each window 58 indicates satisfactory or unsatisfactory quality of experience for that window 58). In particular, analyzer 12 may determine a total application network usage time for this connection during time period T2 (e.g., as part of aggregation window data 64, as part of application quality of experience data 26 in FIG. 1). The total network usage time may be determined by multiplying the total number of valid time windows 58 within time window 62 by the duration of time period T1 (shared by time windows 58). Analyzer 12 may determine a satisfactory application quality of experience time for this connection during time period T2 (e.g., as part of aggregation window data 64, as part of application quality of experience data 26 in FIG. 1). The satisfactory application quality of experience time may be determined by multiplying the number of valid time windows 58, for which the two application data to acknowledgement ratios are greater than the ratio threshold (e.g., a ratio threshold of at least two), by the duration of time period T1. Analyzer 12 may determine an unsatisfactory application quality of experience time for this connection during time period T2 (e.g., as part of aggregation window data 64, as part of application quality of experience data 26 in FIG. 1). The unsatisfactory application quality of experience time may be determined by multiplying the number of valid time windows 58, for which at least one of the two application data to acknowledgement ratios is less than the ratio threshold, by the duration of time period T1.

If desired, other aggregation techniques may be used. In particular, analyzer 12 may reorganize or redistribute burst window data 60 across arbitrary durations of time and may perform ratio analysis across these durations of time and/or may determine the proportion of time during which application quality of experience is satisfactory or unsatisfactory.

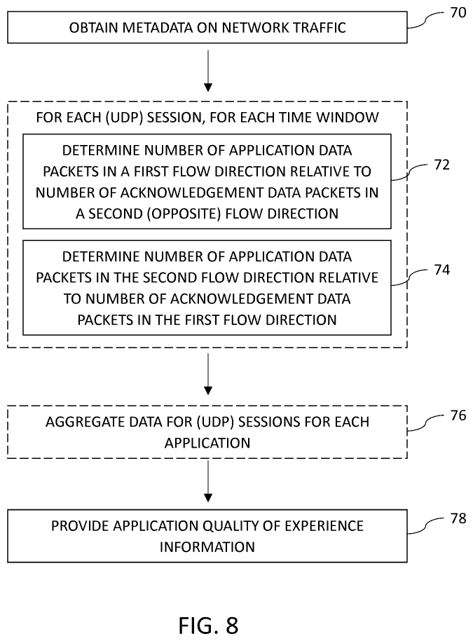

FIG. 8 is a flowchart of illustrative operations performed by a network traffic analyzer (e.g., application quality of experience analyzer 12) to determine (e.g., estimate) application quality of experience. In particular, these operations may be performed by processing circuitry (e.g., compute devices 28 in FIG. 1) for server equipment or other computing equipment for implementing troubleshooting system 22 (FIG. 1), and/or may be performed by processing circuitry (e.g., processing circuitry 34 in FIG. 2) of network device 10. In illustrative configurations described herein as an example, the operations described in connection with FIG. 8 may be performed by the processing circuitry executing software instructions stored on memory circuitry (e.g., storage devices 24) for server equipment or other computing equipment for implementing troubleshooting system 22 and/or stored on memory circuitry (e.g., processing circuitry 36 in FIG. 2) of network device 10. If desired, one or more operations described in connection with FIG. 8 may be performed by any combination of hardware and/or software (implementing the functions of analyzer 12 as described herein).

At block 70, processing circuitry (e.g., for analyzer 12) may obtain metadata on network traffic data (e.g., bidirectional application data traffic for one or more applications). The obtained metadata may include header information that identifies the flow and/or application to which each data packet belongs, may include packet size information usable to identify the type of data packet (e.g., for distinguishing between application data packets 50-1′, application data packets 50-1″, and acknowledgement data packets 50-2), may include timestamp information (e.g., for grouping data packets into corresponding time windows 58), may include the number of packets, may include any other suitable metadata for performing the quality of experience analysis described herein. In illustrative configurations described herein as an example, the processing circuitry may receive the metadata from a network device such as a wireless access point wirelessly coupled to the client device on which the one or more applications are executing).

At block 72, for each time window (e.g., burst time window 58) of each UDP session (e.g., each QUIC connection), the processing circuitry may determine relative numbers of application data packets in a first flow direction to acknowledgement data packets in a second (opposite) flow direction (e.g., an application data to acknowledgement ratio in a transmission direction 56A in FIG. 5). Similarly, at block 74, for each time window (e.g., burst time window 58) of each UDP session (e.g., each QUIC connection), the processing circuitry may determine relative numbers of application data packets in the second flow direction to acknowledgement data packets in the first flow direction (e.g., an application data to acknowledgement ratio in a reception direction 56A in FIG. 5).

In illustrative configurations described herein as an example, the operations performed at blocks 72 and 74 may include the operations performed by analyzer 12 as described in connection with FIGS. 5 and 6. If desired, the relative numbers of application data packets to acknowledgement data packets may further be aggregated across multiple burst time windows (e.g., in the manner described in connection with FIG. 7).

If desired, at block 76, the processing circuitry may further aggregate data for multiple UDP sessions for each application. In other words, a given application may open multiple sessions (e.g., multiple QUIC connections). Accordingly, the ratio analysis performed for multiple sessions may be aggregated to characterize the quality of experience for the single application.

At block 78, the processing circuitry may provide application quality of experience information for each application. For example, the quality of experience information may include indications of quality of experience for each application, such as an indication of quality of experience being satisfactory or unsatisfactory, an indication of a degree to which the quality of experience is satisfactory or unsatisfactory, issues with the quality of experience, application data to acknowledgement ratios generated, thresholds and/or methodology used to generate this information, confidence levels for the quality of experience determination, etc. These different types of quality of experience information may be presented to a device (e.g., device 30) using a presentation platform (e.g., a dashboard), in notifications, and/or using other methods.

The methods and operations described above in connection with FIGS. 1-8 may be performed, using software and/or hardware (e.g., dedicated circuitry or hardware), by the components of a server and/or other host equipment for a troubleshooting system and/or by the components of network devices. Software code for performing these operations may be stored on non-transitory computer-readable storage media (e.g., tangible computer-readable storage media) stored on one or more of the components of the server and/or other host equipment and/or the components of network devices. The software code may sometimes be referred to as software, data, instructions, program instructions, or code. The non-transitory computer-readable storage media may include drives, non-volatile memory such as non-volatile random-access memory (NVRAM), removable flash drives or other removable media, other types of random-access memory, etc. Software stored on the non-transitory computer readable-storage media may be executed by processing circuitry on one or more of the components of the server and/or other host equipment and/or of the components of network devices (e.g., compute devices 28 of system 22 in FIG. 1, processing circuitry 34 of network device 10 in FIG. 2).

The foregoing is merely illustrative and various modifications can be made to the described embodiments. The foregoing embodiments may be implemented individually or in any combination.

What is claimed is:

1. A method for application quality of experience determination, the method comprising:
receiving metadata on network traffic for an application executing on a first host, the network traffic being conveyed between the first host and a second host over a communication connection;
identifying a number of application data packets, in the network traffic, conveyed within a time period from the first host to the second host based on the received metadata;
identifying a number of acknowledgement data packets, in the network traffic, conveyed within the time period from the second host to the first host based on the received metadata; and
providing an indication of quality of experience for the application based on a ratio between the identified number of the application data packets and the identified number of the acknowledgement data packets.

2. The method defined in claim 1 further comprising:
identifying an additional number of additional application data packets, in the network traffic, conveyed within the time period from the second host to the first host based on the received metadata; and
identifying an additional number of acknowledgement data packets, in the network traffic, conveyed within the time period from the first host to the second host based on the received metadata, wherein the indication of quality of experience for the application is further based on an additional ratio between the additional number of additional application data packets and the additional number of additional acknowledgement data packets.

3. The method defined in claim 2 wherein the provided indication comprises a notification of an issue with quality of experience for the application based on the ratio or the additional ratio being less a ratio threshold.

4. The method defined in claim 3, wherein the ratio threshold is an application data packet to acknowledgement data packet ratio of at least two.

5. The method defined in claim 1, wherein the network traffic conveyed over the communication connection comprises data packets each containing transport reliability parameters that are encrypted.

6. The method defined in claim 5, wherein the data packets of the network traffic conveyed over the communication connection each comprise a user datagram protocol (UDP) header and a UDP payload.

7. The method defined in claim 6, wherein the UDP payload of each of the data packets comprises a QUIC packet and wherein the QUIC packet comprises the encrypted transport reliability parameters.

8. The method defined in claim 1, wherein the number of the application data packets is identified by identifying application data packets having sizes greater than an application data packet size threshold.

9. The method defined in claim 8, wherein the number of the acknowledgement data packets is identified by identifying acknowledgement data packets having sizes less than an acknowledgement data packet size threshold.

10. The method defined in claim 9, wherein the indication of quality of experience for the application is provided based on the ratio in response to determining that the time period is for a valid time window.

11. The method defined in claim 10, wherein the time period is determined to be for the valid time window by:
determining that the number of the application data packets is greater than a threshold number of application data packets for the time period; and
determining that the number of the acknowledgement data packets is greater than a threshold number of acknowledgement data packets for the time period.

12. The method defined in claim 1 wherein the indication of quality of experience for the application is provided further based on additional ratios between additional application data packets and additional acknowledgement data packets for additional time periods and wherein the time period and the additional time periods are for an aggregation time window.

13. A network traffic analyzer comprising:
memory circuitry; and
processing circuitry coupled to the memory circuitry and configured to:
obtain information on data packets conveyed across a communication connection established based on a QUIC protocol, the data packets being conveyed between a first host and a second host and for an application executing on the first host;
determine a first ratio of application data packets to acknowledgement data packets for a first set of application data packets in a first network traffic flow from the first host to the second host;
determine a second ratio of application data packets to acknowledgement data packets for a second set of application data packets in a second network traffic flow from the second host to the first host; and
provide an output indicative of quality of experience for the application based on the first and second ratios.

14. The network traffic analyzer defined in claim 13, wherein each application data packet for the first and second sets of application data packets has a packet size that is greater than an application data packet size threshold.

15. The network traffic analyzer defined in claim 13, wherein the output is provided based on comparing each of the first and second ratios to a ratio threshold.

16. The network traffic analyzer defined in claim 15, wherein the output comprises a notification of an issue with quality of experience for the application and wherein the notification is provided based on at least one of the first or second ratios being less than the ratio threshold.

17. A troubleshooting system comprising:
memory circuitry; and
processing circuitry coupled to the memory circuitry and configured to:
identify first application data packets for an application, the first application data packets being conveyed from a first host executing the application to a second host;
identify second application data packets for the application, the second application data packets being conveyed from the second host to the first host;
determine a first ratio between the first application data packets and first acknowledgement data packets, the first acknowledgement data packets being conveyed from the second host to the first host and being responsive to the first application data packets;
determine a second ratio between the second application data packets and second acknowledgement data packets, the second acknowledgement data packets being conveyed from the first host to the second host and being responsive to the second application data packets;
compare each of the first and second ratios to a ratio threshold; and
based on results of the first and second ratios being compared to the ratio threshold, provide an output indicative of quality of experience for the application.

18. The troubleshooting system defined in claim 17, wherein the provided output is indicative of an issue with quality of experience for the application based on at least one of the first ratio or the second ratio not exceeding the ratio threshold.

19. The troubleshooting system defined in claim 17, wherein the first application data packets, the second application data packets, the first acknowledgement data packets, the second acknowledgement data packets each comprise a QUIC packet encapsulated with a user datagram protocol (UDP) header.

20. The troubleshooting system defined in claim 17, wherein the first and second ratios are determined for a first time window, wherein the processing circuitry is configured to determine additional ratios between application data packets and acknowledgement packets for additional time windows, and wherein the output is provided based on additional results of the additional ratios being compared to the ratio threshold.
